(19) United States
(12) Patent Application Publication
(10) Pub. No.: US 2018/0035654 A1
(43) Pub. Date: Feb. 8, 2018

(54) Fishing Spoon with Reinforcing Perimeter Edge

(71) Applicant: John Everett King, Manistee, MI (US)

(72) Inventor: John Everett King, Manistee, MI (US)

(21) Appl. No.: 15/665,130

(22) Filed: Jul. 31, 2017

Related U.S. Application Data
(60) Provisional application No. 62/371,923, filed on Aug. 8, 2016.

(51) Int. Cl. A01K 91/08; A01K 85/16; A01K 85/14

(52) U.S. Cl. CPC A01K 91/08; A01K 85/14; A01K 85/16; A01K 93/00

(57) ABSTRACT

A fishing spoon with reinforcing perimeter edge is a fishing lure designed to dart and wobble through the water as the fishing lure is trolled through the water. The fishing spoon with reinforcing perimeter edge includes a spoon body, a concave surface, a convex surface, a reinforcing edge, a hook attachment hole, and a line attachment hole. The concave surface and the convex surface are integrated into the spoon body to cause the spoon body to dart and wobble as the spoon body is trolled through the water. The reinforcing edge is perimetrically connected to the concave surface to further influence the motion of the spoon body through the water. The hook attachment hole traverses through the spoon body to allow a fishing hook to couple with the spoon body. The line attachment hole traverses through the spoon body to allow a fishing line to couple with the spoon body.

The current application claims a priority to the U.S. Provisional Patent application Ser. No. 62/371,923 filed on Aug. 8, 2016.

### FIELD OF THE INVENTION

The present invention relates generally to a fishing spoon. More specifically, the present invention is a fishing spoon with a reinforced outer perimeter that channels water for a wobbling and darting action in order to entice fish to bite onto an attached fishing hook.

### BACKGROUND OF THE INVENTION

There are many types of fishing lures including: spinners, jigs, plugs, soft plastic baits, spinner baits, flies, and spoons. In general, each type of fishing lure is designed for a specific type of fish. The spoon, however, is the most universal type of fishing lure. Spoons are curved lures that originally were the heads of actual spoons that were broken off. Today, spoons come in a variety of shapes and sizes and have a variety of accessories. However, traditional fishing spoons do not attract fish quite effectively given the traditional fishing spoon's simple structure.

The present invention is a fishing spoon with reinforcing perimeter edge. The object of the present invention is to provide a more efficient lure than previous. The present invention wobbles and darts in the water unlike traditional fishing lures, due to its reinforcing perimeter edge, to entice fish to bite the lure. The present invention comprises a hook attachment hole and a line attachment hole to accommodate a hook and line. The present invention may comprise additional components that increase its attractiveness for fish, such as reflective components and fluorescent colors. The fishing spoon with reinforcing perimeter edge is more tapered to one end, unlike traditional lures, which further changing the hydrodynamic properties to create a more efficient fishing experience.

### BRIEF DESCRIPTION OF THE DRAWINGS

FIG. 1 is a perspective view of the present invention.

FIG. 2 is a top view of the present invention.

FIG. 3 is a bottom view of the present invention, wherein a global maximum of the convex surface is opposite to a global maximum of the convex surface in FIG. 2.

FIG. 4 is a left-side view of the present invention.

FIG. 5 is a right-side view of the present invention.

FIG. 6 is a front view of the present invention.

FIG. 7 is a rear view of the present invention.

FIG. 8 is a cross-sectional view of the spoon body for the present invention, along the line A-A in FIG. 3.

### DETAIL DESCRIPTIONS OF THE INVENTION

All illustrations of the drawings are for the purpose of describing selected versions of the present invention and are not intended to limit the scope of the present invention.

The present invention is a fishing spoon with reinforcing perimeter edge. The present invention is a fishing lure designed to dart and wobble through the water as the present invention is trolled through the water. The motion of the present invention through water intends to attract fish to bite into bait placed onto a fishing hook to catch the fish.

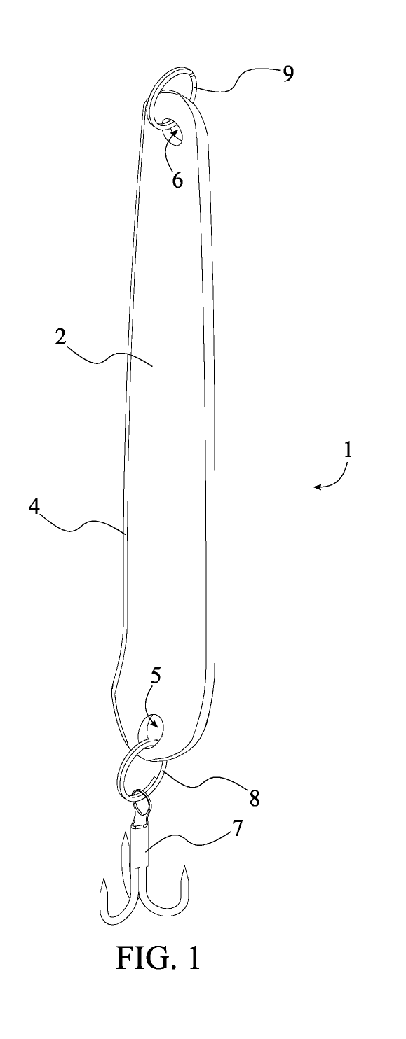

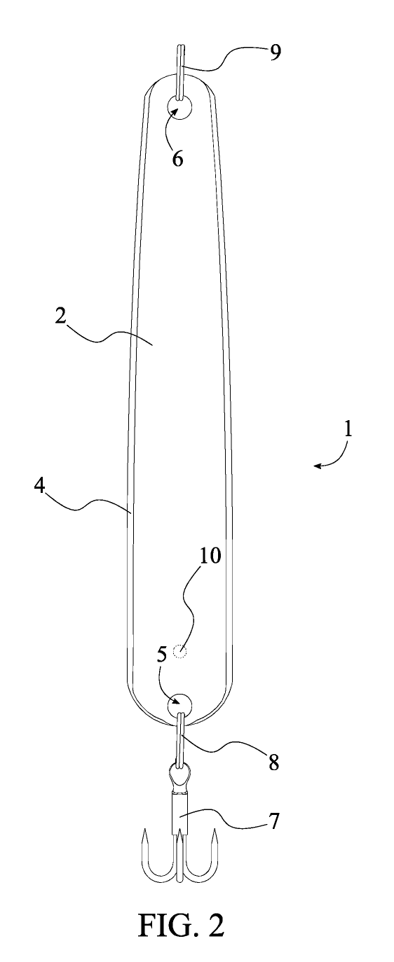

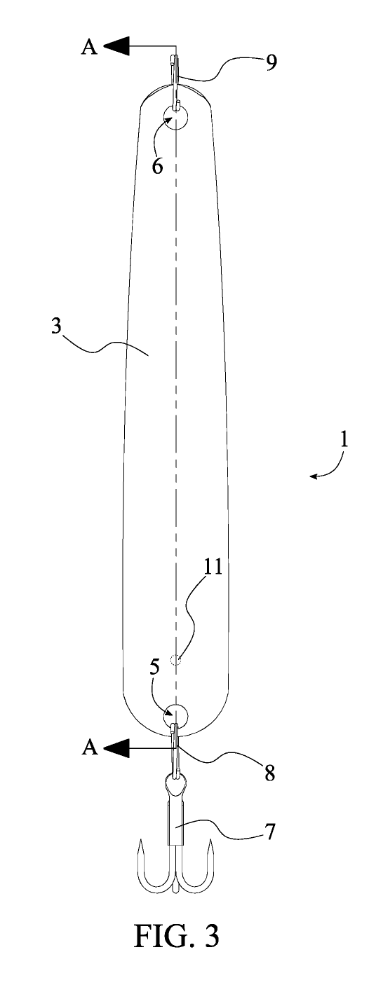

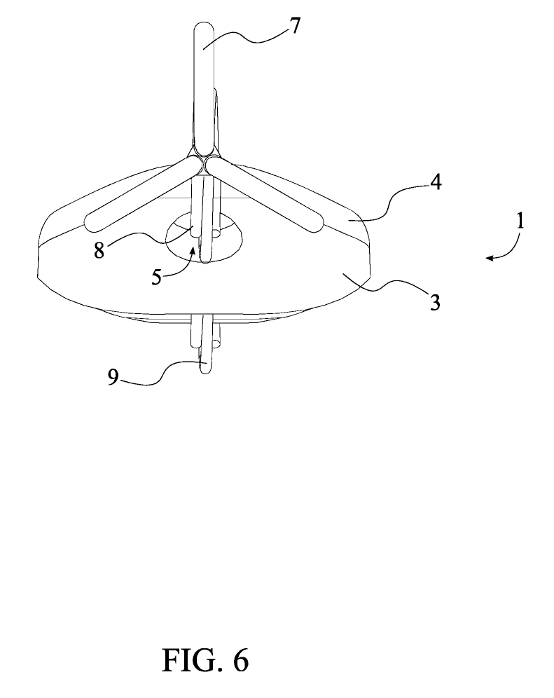

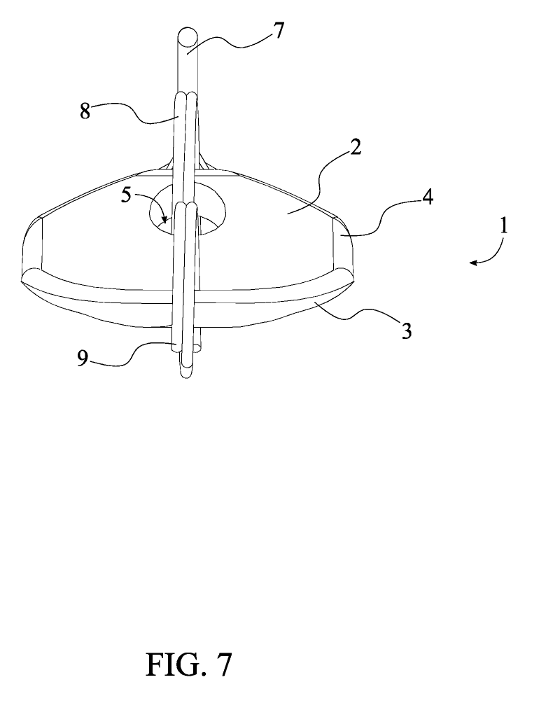

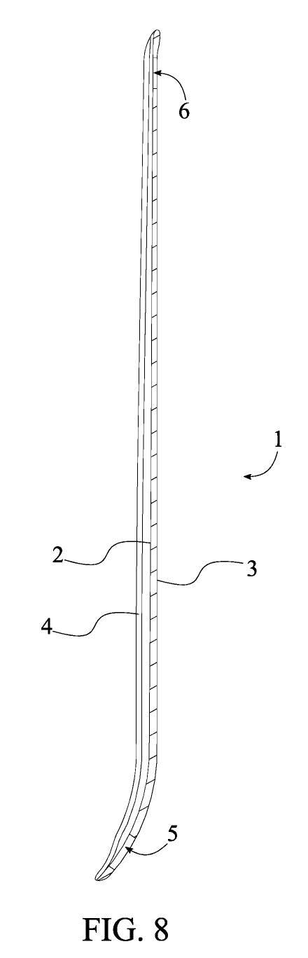

The present invention comprises a spoon body 1, a concave surface 2, a convex surface 3, a reinforcing edge 4, a hook attachment hole 5, and a line attachment hole 6, in accordance to FIG. 1 to FIG. 3. The spoon body 1 is the portion of the present invention that darts and wobbles as the present invention is trolled through the water. The concave surface 2, shown in FIG. 1 and FIG. 2, and the convex surface 3, shown in FIG. 3, affect the hydrodynamic properties of the present invention to allow the spoon body 1 to dart and wobble through the water. The concave surface 2 is integrated with the spoon body 1. The convex surface 3 is integrated with the spoon body 1. The concave surface 2 is positioned opposite to the convex surface 3, about the spoon body 1, in order to generate hydrodynamic lift as the present invention traverses through water. The reinforcing edge 4 is perimetrically connected about the concave surface 2, in accordance to FIG. 1, FIG. 2, and FIG. 7. The reinforcing edge 4 further influences the hydrodynamics of the present invention, by changing the behavior of the flow of water around the present invention as the present invention is trolled through the water. The hook attachment hole 5 allows a fishing hook 7 to be attached in order to catch a fish. The hook attachment hole 5, shown in FIG. 1 to FIG. 3 and FIG. 6 to FIG. 8, traverses through the concave surface 2, the convex surface 3, and the spoon body 1. Similarly, the line attachment hole 6, shown in FIG. 1 to FIG. 3 and FIG. 8, allows the present invention to be affixed to a fishing line. The line attachment hole 6 traverses through the concave surface 2, the convex surface 3 and the spoon body 1. The hook attachment hole 5 is positioned opposite to the line attachment hole 6, along the spoon body 1, such that the fishing line is in tension through the spoon body 1 as a fish is set on the fishing hook 7.

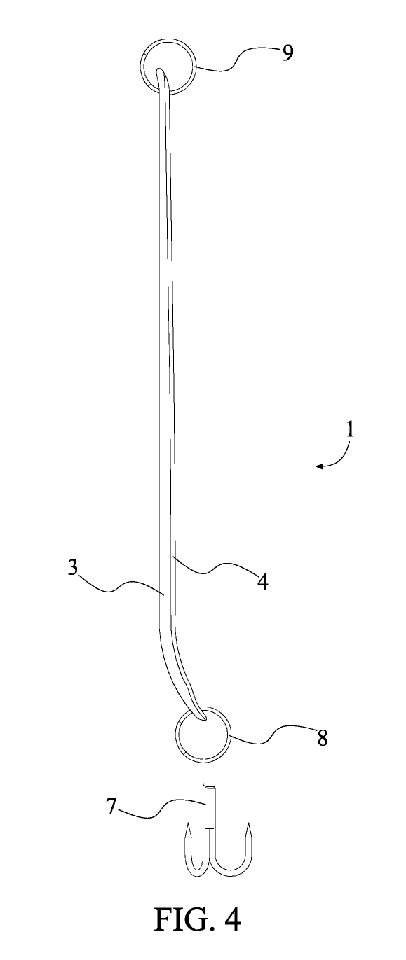

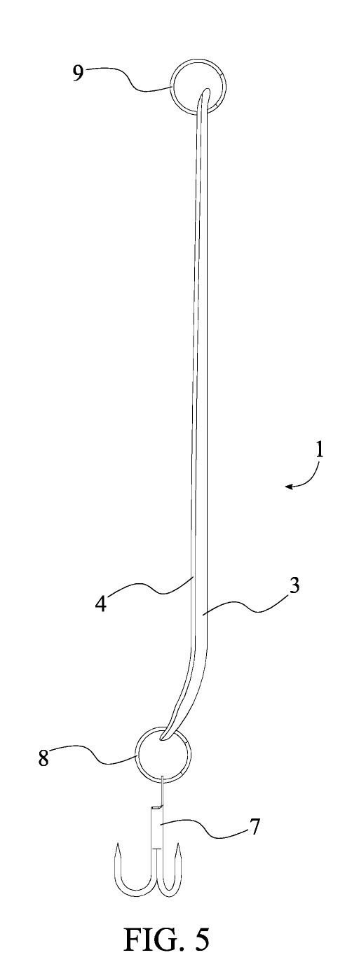

Further in accordance to the preferred embodiment of the present invention, the present invention comprises a fishing hook 7, detailed in FIG. 1 to FIG. 7. The fishing hook 7 allows bait to be attached to the present invention in an effort to secure a fish on the fishing hook 7 as the fish attempts to consume the bait. The fishing hook 7 is coupled with the spoon body 1 through the hook attachment hole 5.

In some embodiments of the present invention, the present invention comprises a hook split ring 8, in accordance to FIG. 1 to FIG. 7. The hook split ring 8 allows for the fishing hook 7 to be interchangeable with other fishing hooks. The hook split ring 8 is coupled with the spoon body 1 through the hook attachment hole 5. The fishing hook 7 is then coupled to the hook attachment hole 5, through the hook split ring 8, such that the fishing hook 7 is able to be easily removed from the spoon body 1 and exchanged with another fishing hook.

In accordance to another embodiment of the present invention, the present invention comprises a line split ring 9, in accordance to FIG. 1 to FIG. 7. The line split ring 9 allows the present invention to be quickly attached to a fishing line of a fishing rod. The line split ring 9 is coupled with the spoon body 1 through the line attachment hole 6, in order to fasten the fishing line to the present invention efficiently.

The spoon body 1 is preferred to be made from polycarbonate; however, the spoon body 1 may be made from other polymers, metals, or appropriate materials to withstand the tension through the spoon body 1 from the resistance of a fifty-pound fish. The spoon body 1 is further preferred to be approximately 0.077 inches (in.) in thickness, such that the spoon body 1 does not shear in half from the resistance forces of a fish as the user reels in the fish. In some embodiments of the spoon body 1, the spoon body 1 is approximately 3.75 in. in length. In some other embodiments of the spoon body 1, the spoon body 1 is approximately 4.65 in. in length. Either the 3.75 in. or the 4.65 in. length of the spoon body 1 is applicable for most situations; however, due to the different lengths of the spoon body 1, the present invention would behave differently as the spoon body 1 is trolled through the water.

Further in accordance to the preferred embodiment of the present invention, a global maximum 10 of the concave surface 2 is positioned adjacent to the hook attachment hole 5, shown in FIG. 2. Similarly, a global maximum 11 of the convex surface 3 is positioned adjacent to the hook attachment hole 5, shown in FIG. 3. The global maximum 10 of the concave surface 2 is positioned opposite to the global maximum 11 of the convex surface 3 about the spoon body 1. This configuration allows for the darting or wobbling movement of the present invention due to the flow of water across the convex surface 3 and concave surface 2 from the line attachment hole 6 to the hook attachment hole 5 as the present invention is trolled through the water. Further, the spoon body 1 is tapered from the global maximum 11 of the concave surface 2 to the line attachment hole 6 in order for flow of water to reduce drag from the spoon body 1 adjacent to the line attachment hole 6.

Although the invention has been explained in relation to its preferred embodiment, it is to be understood that many other possible modifications and variations can be made without departing from the spirit and scope of the invention as hereinafter claimed.

What is claimed is:

1. A fishing spoon with reinforcing perimeter edge comprises:
a spoon body;
a concave surface;
a convex surface;
a reinforcing edge;
a hook attachment hole;
a line attachment hole;
the concave surface being integrated with the spoon body;
the convex surface being integrated with the spoon body;
the concave surface being positioned opposite to the convex surface, about the spoon body;
the reinforcing edge being perimetrically connected about the concave surface;
the hook attachment hole traversing through the concave surface, the convex surface, and the spoon body;
the line attachment hole traversing through the concave surface, the convex surface, and the spoon body; and
the hook attachment hole being positioned opposite to the line attachment hole, along the spoon body.

2. The fishing spoon with reinforcing perimeter edge, as claimed in claim 1, comprises:
a fishing hook; and
the fishing hook being coupled with the spoon body through the hook attachment hole.

3. The fishing spoon with reinforcing perimeter edge, as claimed in claim 4, comprises:
a hook split ring; and
the fishing hook being coupled to the hook attachment hole, through the hook split ring.

4. The fishing spoon with reinforcing perimeter edge, as claimed in claim 1, comprises:
a hook split ring; and
the hook split ring being coupled with the spoon body through the hook attachment hole.

5. The fishing spoon with reinforcing perimeter edge, as claimed in claim 1, comprises:
a line split ring; and
the line split ring being coupled with the spoon body through the line attachment hole.

6. The fishing spoon with reinforcing perimeter edge, as claimed in claim 1, wherein the spoon body is polycarbonate.

7. The fishing spoon with reinforcing perimeter edge, as claimed in claim 1, wherein the spoon body is approximately 0.077 inches (in.) in thickness.

8. The fishing spoon with reinforcing perimeter edge, as claimed in claim 1, wherein the spoon body is approximately 3.75 inches (in.) in length.

9. The fishing spoon with reinforcing perimeter edge, as claimed in claim 1, wherein the spoon body is approximately 4.65 inches (in.) in length.

10. The fishing spoon with reinforcing perimeter edge, as claimed in claim 1, comprises:
a global maximum of the concave surface being positioned adjacent to the hook attachment hole.

11. The fishing spoon with reinforcing perimeter edge, as claimed in claim 1, comprises:
a global maximum of the convex surface being positioned adjacent to the hook attachment hole.

12. The fishing spoon with reinforcing perimeter edge, as claimed in claim 11, comprises:
the spoon body being tapered from the global maxima of the concave surface to the line attachment hole.

13. The fishing spoon with reinforcing perimeter edge, as claimed in claim 1, comprises:
a global maximum of the concave surface being positioned opposite to a global maximum of the convex surface, about the spoon body.
